(19) United States
(12) Patent Application Publication
(10) Pub. No.: US 2008/0152503 A1
(43) Pub. Date: Jun. 26, 2008

(54) FAN CAPABLE OF INCREASING FLUID PRESSURE

(76) Inventor: SHI-PING LUO, Kaohsiung (TW)

Correspondence Address: G. LINK CO., LTD., 3550 BELL ROAD, MINOOKA, IL, 60447, US

(21) Appl. No.: 11/613,377

(22) Filed: Dec. 20, 2006

(51) Int. Cl. B64C 11/16

(52) U.S. Cl. 416/223 R

(57) ABSTRACT

A fan capable of increasing pressure of fluid provides a hub and fan blades. The hub has a flat facial end and a circumferential side. The fan blades extend radially from the circumferential side of the hub. Each of the fan blades has a joining end being attached to the circumferential side and a free end extending outward the hub and a front edge and a rear edge being between the joining end and the free end. The rear edge of the respective fan blade is shielded by the front edge of another fan blade next to it and the unshielded portion of the respective fan blade has an area gradually increases from the joining end to the free end such that the pressure of fluid at the free end is greater than that at the joining end.

### BACKGROUND OF THE INVENTION

1. Field of the Invention

The present invention is related to a fan capable increasing fluid pressure and particularly to a device capable of increasing pressure of fluid moving outward the fan.

2. Brief Description of the Related Art

Referring to FIGS. 1 and 2, the conventional fan provides a hub 11 and a plurality of fan blades 12. The hub 11 is cylindrical with a flat facial end 111 having an area identical to the rear end thereof. The fan blades 12 surrounding the hub 11 each have a front edge 121 and a rear edge 122 with a gap 13 between every two adjacent fan blades 12, that is, the respective fan blade 12 is unshielded with another fan blade 12 next to it.

The problem of the preceding conventional fan is in that when the fan is in operation, the gap 13 becomes flow passage and fluid can pass outward through the gap 13. However, the fluid being acted by the fan blades 12 becomes less and it leads to pressure of the fluid moving outward being small. In addition, the fluid flows axially and diffuses outward immediately instead of gathering as a fluid beam while moving outward. Hence, effect of heat dissipation is unfavorable.

### SUMMARY OF THE INVENTION

In order to solve the preceding problem, an object of the present invention is to provide a fan with spiral supercharging device in which the fan blades overlap partly to each other and a projection is arranged at the free end of the respective fan blade along a direction of fluid flow for increasing fluid pressure and guiding fluid flowing toward the hub.

Accordingly, a fan capable of increasing pressure of fluid according to the present invention has a hub and a plurality of fan blades. A hub has a flat facial end and a circumferential side. The fan blades extend radially from the circumferential side of the hub. Each of the fan blades has a joining end being attached to the circumferential side, a free end extending outward the hub and a front edge and a rear edge being between the joining end and the free end respectively. The rear edge of the respective fan blade is shielded by the front edge of another fan blade next to it. The unshielded portion of the respective fan blade has an area gradually increases from the joining end to the free end such that the pressure of fluid at the free end is greater than that at the joining end.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a perspective view of the conventional fan;

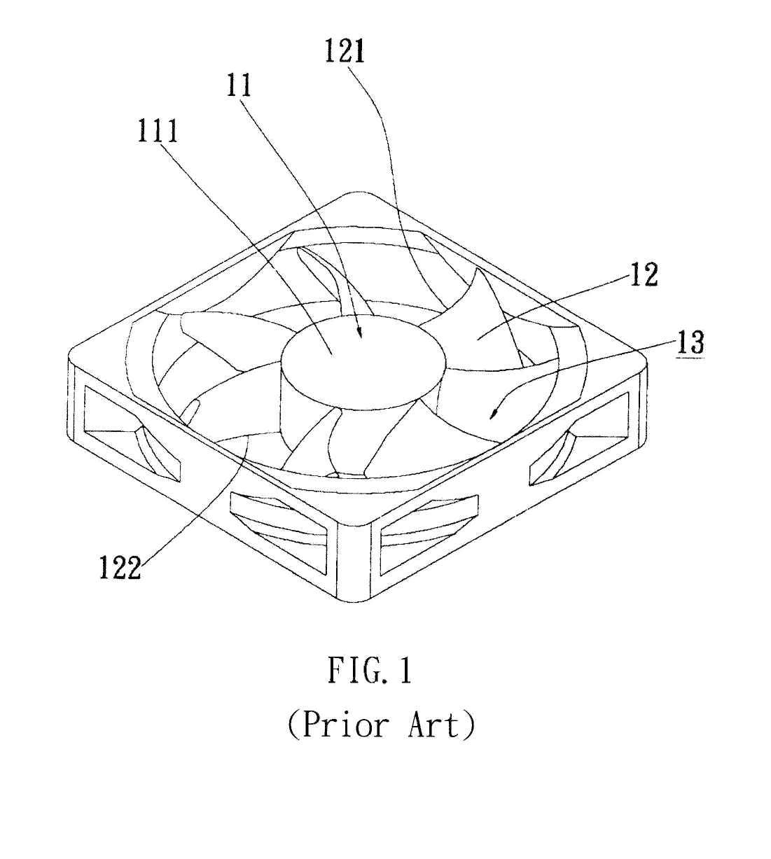

FIG. 2 is a sectional view of the conventional fan shown in FIG. 1;

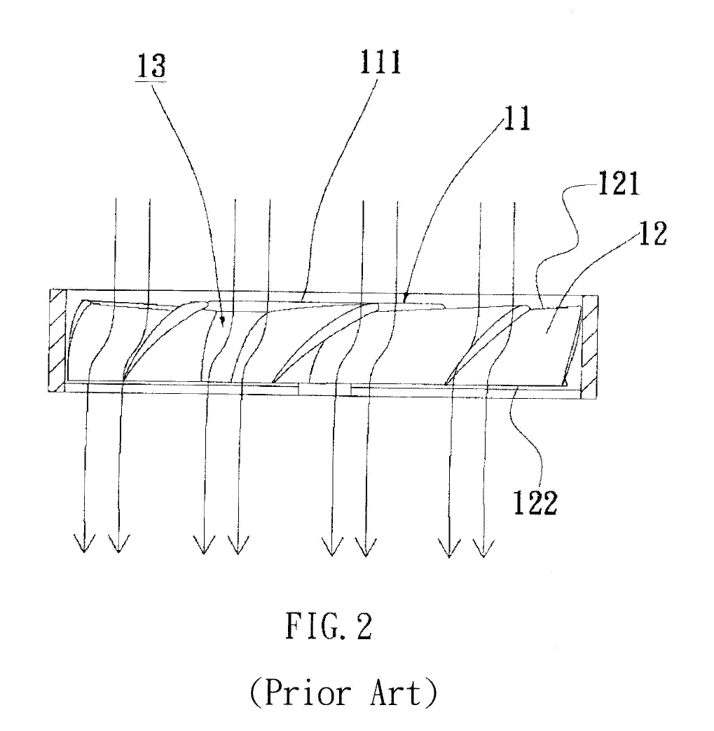

FIG. 3 is a perspective view of a fan capable of increasing pressure of fluid according to the present invention;

FIG. 4 is a top view of the fan shown in FIG. 3;

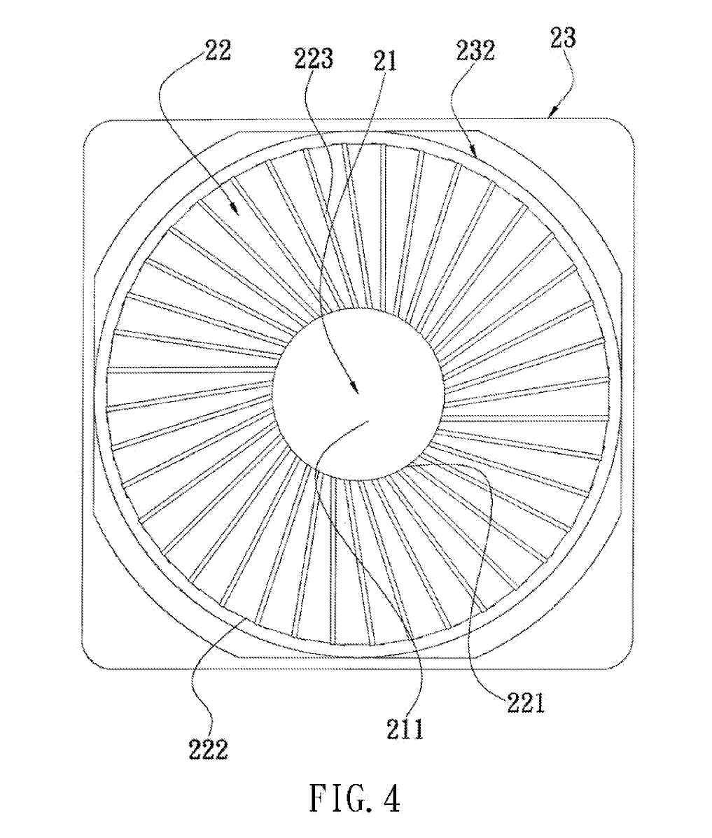

FIG. 5 is a sectional view of the fan shown in FIG. 3; and

FIG. 6 is a sectional view illustrating the fan capable of increasing pressure of fluid according to the present invention being attached to a heat sink.

### DETAILED DESCRIPTION OF THE INVENTION

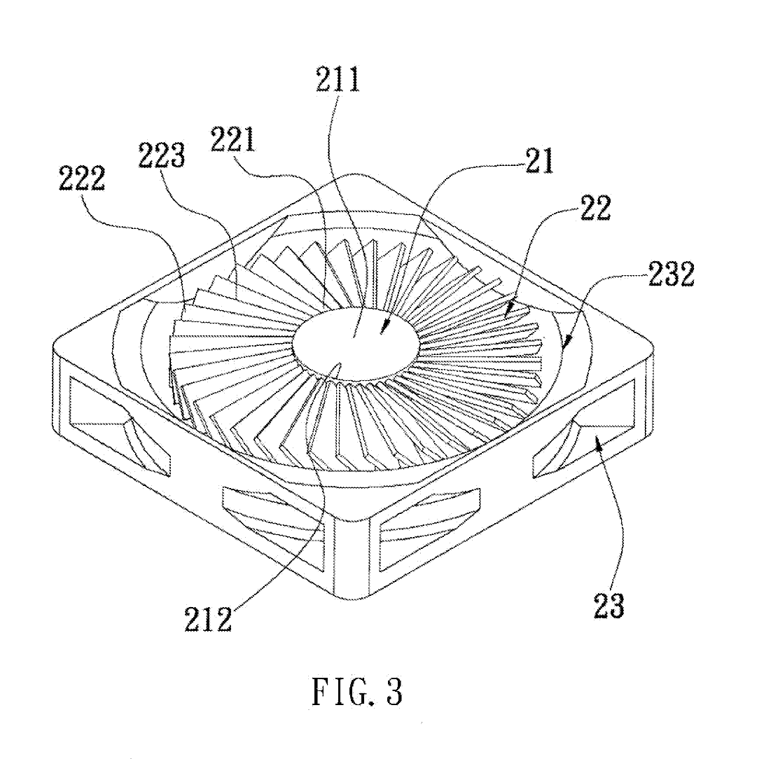

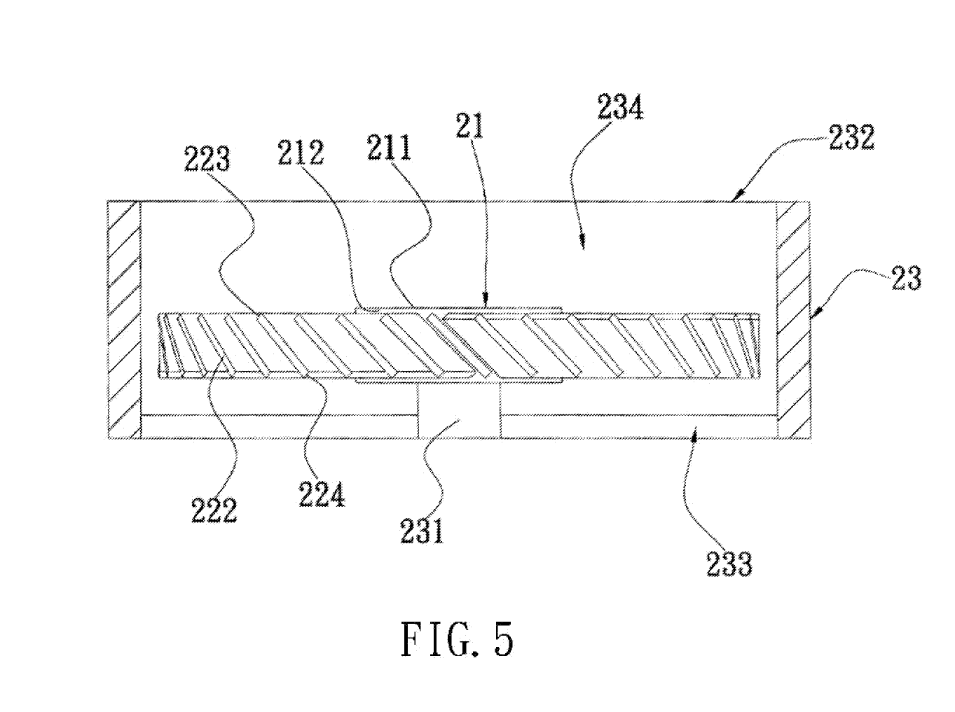

Referring to FIGS. 3 and 5, a fan capable of increasing fluid pressure according to the present invention includes a hub 21 and a plurality of fan blades 22. The hub 21 has a facial end 211 and a circumferential side 212. The facial end 211 is a flat surface and a receiving chamber is defined by the facial end 211 and the circumferential side 212 with an open rear end for receiving a motor stator and a rotor (not shown).

Each of the fan blades 22 has a joining end 221 and a free end 222, a front edge 223 and a rear edge 224 as shown in FIG. 5. The joining end 221 is fixedly attached to the circumferential side 212 of the hub 21 and free end 222 extends outward the hub 21. The front edge 223 and the rear edge 224 are two radial sides of the respective fan blade 22. The rear edge 224 of each fan blade is shielded by the front edge 223 of another fan blade next to it and the unshielded part of the respective fan blade has a width increasing gradually from the joining end 221 to the free end 222. Hence, the respective fan blade 22 has a spiral shape.

A fan frame 23 has a first opening 232 and a second opening along the axial direction thereof. A flow passage 234 communicates with the first and second openings 232, 233. A base 231 is disposed in the flow passage 234 near the second opening 233. The hub 21 with the fan blades 22 is movably fits with the base 231. When the hub 21 with the fan blades 22 rotates, fluid is driven to pass a space between every two fan blades 22. The unshielded area of the respective fan blade 22 is small near the joining end 221 such that fluid passes the small unshielded area subjects to small acting force and it results in less pressure while the unshielded area of the respective fan blade 22 near the free end 222 is large such that the fluid passes the large unshielded area subjects to large acting force and it results in more pressure. That is, small fluid pressure is close to the joining end 221 and large fluid pressure is close to the free end 222. The fluid with large pressure usually flows toward the fluid with small pressure such that the fluid passes the free end 222 moves toward the joining end 221. Under this circumference, the fluid flowing outward via the fan blades 22 is capable of congregating as a fluid beam at the joining end 221 while leaving the fan blades 22 and preventing from diffusing outward immediately.

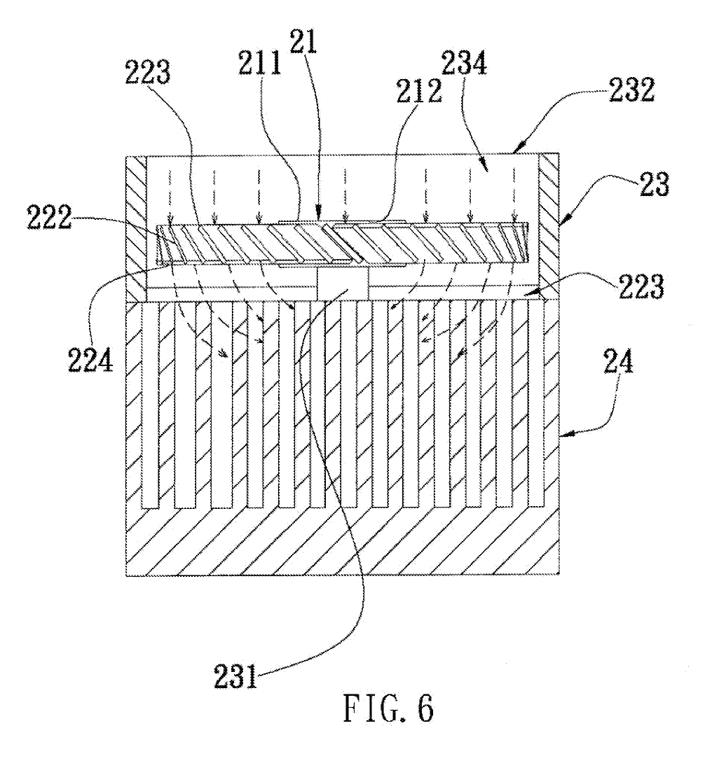

Referring to FIG. 6 in company with FIG. 3, the fan frame 23 is mounted to a hot object 24 in a way of the tip 211 of the hub 21 being next to the central position of the top of the heat sink 24. The hot object 24 can be a heat sink or a central processing unit (CPU). Once the hub 21 with the fan blades 22 is driven to rotate, fluid is induced by the fan blades 22 to enter the fan frame via the first opening 232 and then flow outward via the second opening 233 toward the hot object 24. The fluid passing the fan blades 22 can gather at the joining end 221 of the respective fan blade 22 and moves along the circumferential side of the hub 21 so as to flow to the center of the hot object 24 for solving the problem of the center of the heat sink being a zone with highest heat and enhancing efficiency of heat dissipation.

While the invention has been described with referencing to a preferred embodiment thereof, it is to be understood that modifications or variations may be easily made without departing from the spirit of this invention, which is defined by the appended claims.

What is claimed is:

1. A fan capable of increasing pressure of fluid comprising:
a hub having a flat facial end and a circumferential side; and
a plurality of fan blades extending radially from the circumferential side of the hub;
wherein each of the fan blades has a joining end being attached to the circumferential side and a free end extending outward the hub and a front edge and a rear edge being between the joining end and the free end; the rear edge of the respective fan blade is shielded by the front edge of another fan blade next to it; and unshielded portion of the respective fan blade has an area gradually increases from the joining end to the free end such that the pressure of fluid at the free end is greater than that at the joining end.

2. The fan with spiral supercharging device as defined in claim 1, wherein the hub is disposed in a fan frame.
